(19) United States
(12) Patent Application Publication
(10) Pub. No.: US 2018/0304551 A1
(43) Pub. Date: Oct. 25, 2018

(54) METHOD OF FEEDING AND RETURNING FILAMENT FOR 3D PRINTER

(71) Applicants: XYZPRINTING, INC., NEW TAIPEI CITY (TW); KINPO ELECTRONICS, INC., NEW TAIPEI CITY (TW)

(72) Inventor: Yu-Chi CHEN, NEW TAIPEI CITY (TW)

(21) Appl. No.: 15/634,981

(22) Filed: Jun. 27, 2017

(30) Foreign Application Priority Data
Apr. 20, 2017 (CN) 201710261080.X

(51) Int. Cl. B29C 67/00; B33Y 10/00; B33Y 50/02

(52) U.S. Cl. CPC B29C 67/0088; B33Y 50/02; B33Y 10/00; B29C 67/0055

(57) ABSTRACT

A method of feeding and returning filament for 3D printer includes receiving a first operation input at a button on the 3D printer; controlling the 3D printer to enter a feeding and returning mode after receiving the first operation input, receiving a second operation input, determining an operation content of the second operation input; performing feeding operation when the operation content matching a first condition, and performing returning operation when the operation content matching a second condition.

### BACKGROUND OF THE INVENTION

### Field of the Invention

The technical field relates to a 3D printer, especially to a method of feeding and returning filament for 3D printer.

### Description of Prior Art

Manufacturers of printers generally design the printer to have specific button on casing thereof to enhance operational convenience of user. Therefore, user can quickly perform operations by pressing the buttons. For example, the existing printer has a button thereon for adjusting position of nozzle, button controlling filament feeding, and button controlling filament returning etc., user can directly press the buttons for performing corresponding operation.

For users, the provision of buttons facilitates operation for them. However, excessive buttons occupy considerable space on casing of printer and increase cost. The number of the buttons should be limited for aesthetic and cost considerations. Nevertheless, printer with buttons of reduced number has poor operability. It is desired to provide an operation method using buttons of reduced number and still having satisfactory operability.

### SUMMARY OF THE INVENTION

The disclosure is directed to provide a method of feeding and returning filament for 3D printer to operate the 3D printer with limited number of buttons.

In an exemplary embodiment of the present disclosure, the method of feeding and returning filament is mainly used for a 3D printer having a single button, and including the following steps: receiving a first operation input by the 3D printer through the button; controlling the 3D printer to enter a feeding and returning filament mode after receiving the first operation input, and to receive a second operation input in the feeding and returning filament mode; determining an operation content of the second operation input while receiving the second operation input; performing a feeding operation in the feeding and returning filament mode while the operation content matching a first condition, wherein the feeding is used for adding a filament to the 3D printer; and performing a returning operation in the feeding and returning filament mode while the operation content matching a second condition, wherein the returning operation is used for making the 3D printer return the filament.

In an exemplary embodiment, the method of feeding and returning filament further includes a step: controlling the 3D printer to enter a standby mode if the second operation input being not received within a specific time period.

In an exemplary embodiment, the method of feeding and returning filament further includes a step: controlling the 3D printer to enter a standby mode, if a third operation input being received in the feeding and returning filament mode. The third operation input is different from the second operation input.

In an exemplary embodiment, the third operation input is keeping pressing the button and for a predetermined time period.

In an exemplary embodiment, the predetermined time period is larger than or equal to 3 sec.

In an exemplary embodiment, the method of feeding and returning filament further includes a step: controlling the 3D printer to enter a standby mode after the feeding operation or the returning operation being finished.

In an exemplary embodiment, the first operation input is keeping pressing the button for a predetermined time period.

In an exemplary embodiment, the predetermined time period is larger than or equal to 3 sec.

In an exemplary embodiment, the first operation input is a specific number of pressing on the button within a short pressing time.

In an exemplary embodiment, the second operation input is a button input, the 3D printer determines the operation content matching the first condition, while the button input is pressing the button with a first pressing frequency. The 3D printer determines the operation content matching the second condition, while the button input is pressing the button with a second pressing frequency. The first pressing frequency is different from the second pressing frequency.

In an exemplary embodiment, the second operation input is a detection input, the 3D printer determines the operation content matching the first condition, if the detection input is no filament detected in a specific time period. The 3D printer determines the operation content matching the second condition, if the detection input is the filament detected in the specific time period.

In an exemplary embodiment, the 3D printer receives the first operation input in a standby mode.

In an exemplary embodiment, the 3D printer has at least a single color LED, the 3D printer sets a pulse width of the single color LED to be a maximal value in a standby mode to make the single color LED be a constant light, while the 3D printer decreases the pulse width of the single color LED from 100% to 0% of the maximal value in the feeding operation or the returning operation, by decreasing in a speed of a fixed rate in a fixed time interval, then increases the pulse width of the single color LED from 0% to 100% of the maximal value, by increasing in the speed to make the single color LED be a breathing light.

The method of feeding and returning filament provided by the present disclosure can operate the 3D printer with limited number of buttons and enhance convenience for operation.

### BRIEF DESCRIPTION OF DRAWING

One or more exemplary embodiments of the present disclosure are illustrated by way of example and not limitation in the figures of the accompanying drawings, in which like references indicate similar elements. These drawings are not necessarily drawn to scale.

FIG. 1 shows a flowchart of a method of feeding and returning filament according to a first exemplary embodiment of the present disclosure.

FIG. 2 shows a flowchart of a method of feeding and returning filament according to a second exemplary embodiment of the present disclosure.

FIG. 3 shows a flowchart of a method of feeding and returning filament according to a third exemplary embodiment of the present disclosure.

FIG. 4 shows a flowchart of a method of feeding and returning filament according to a fourth exemplary embodiment of the present disclosure.

FIG. 5 shows a diagram of a 3D printer using the method according to a first exemplary embodiment of the present disclosure.

### DETAILED DESCRIPTION OF THE INVENTION

The present disclosure provides a method of feeding and returning filament for a 3D printer. This method is mainly used for a 3D printer having a single button thereon to and makes the 3D printer perform filament mounting (that is, feeding filament) and dismounting (that is, returning filament). The filament is forming material used by the 3D printer for 3D printing, and the filament is mainly mounted at a nozzle of the 3D printer. If the 3D printer finishes feeding operation, the nozzle sprays the forming material on a printing platform, for printing a physical 3D model.

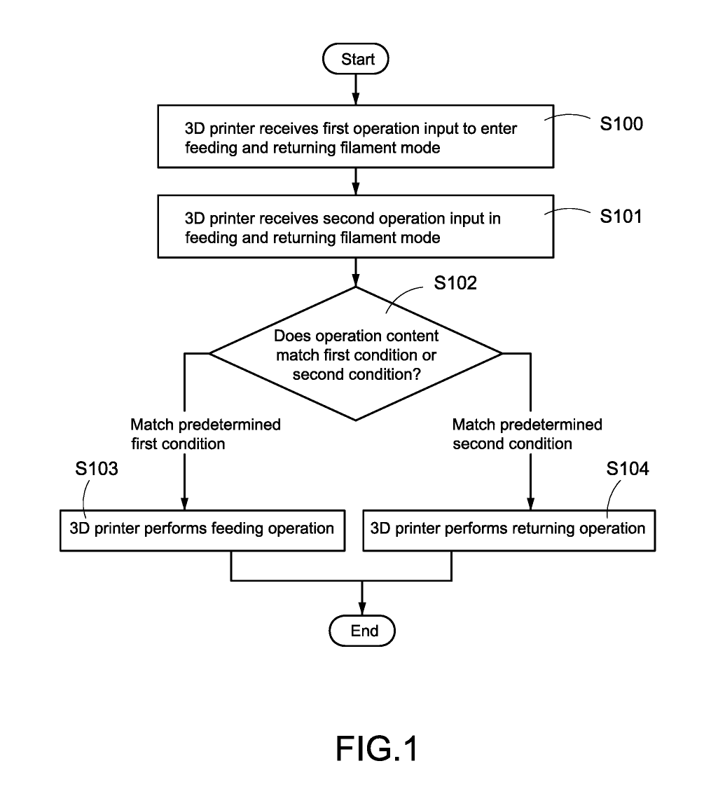

Please refer to FIG. 1, FIG. 1 shows a flowchart of a method of feeding and returning filament according to a first exemplary embodiment of the present disclosure. As shown in FIG. 1, firstly, in step S100 the 3D printer receives a first operation input. In the present disclosure, the 3D printer mainly receives the first operation input through the button, that is, the first operation input mainly is a button input.

In an exemplary embodiment, the first operation input is keeping pressing (holding down) the button for a predetermined time period. The predetermined time period may be, for example, larger than or equal to 3 sec, larger than or equal to 5 sec etc. In another exemplary embodiment, the first operation input may be pressing (clicking) the button for a specific number of times in a short pressing time (for example, pressing on the button for three times in 2 sec). It needs to be note that, in step S100, the 3D printer receives the first operation input when powered on in a standby mode, and then performs step S101, but not limited.

In the present disclosure, the 3D printer enters, after receiving the first operation input, a feeding and returning filament mode of the 3D printer and then waits. In step S101 the 3D printer receives a second operation input in the feeding and returning filament mode, in this way, the 3D printer may determine, according to a content of the second operation input to perform a feeding operation or a returning operation of the feeding and returning filament mode. In an exemplary embodiment, the second operation input is a button input of the user pressing the button. Specifically, the 3D printer determines if the second operation input is received according to whether the button is pressed again in the feeding and returning filament mode.

Then, in step S102 the 3D printer determines an operation content of the second operation input. Specifically, the 3D printer compares the operation content of the second operation input with a plurality of predetermined conditions to determine to control the 3D printer to perform the feeding operation or the returning operation of the feeding and returning filament mode. In an exemplary embodiment, the plurality of conditions mentioned above may be stored in a memory of the 3D printer, or be written to a firmware of the 3D printer in advance, not limited.

If the 3D printer determines that the operation content matches a predetermined first condition, the 3D printer enters step S103. In step S103 the 3D printer performs the feeding operation of the feeding and returning filament mode. Specifically, the feeding operation is mainly used to heat a nozzle of the 3D printer, and to add a filament for the 3D printer performing 3D printing to the nozzle to finish preparation for 3D printing.

In an exemplary embodiment, the first condition records a first pressing frequency, step S102 determines the operation content of the second operation input matches the first condition if the user presses the button with the first pressing frequency (that is, the operation content of the second operation input is pressing the button with the first pressing frequency).

If the 3D printer determines that the operation content matches a predetermined second condition, the 3D printer enters step S104. In step S104 the 3D printer performs the returning operation of the feeding and returning filament mode. Specifically, the returning operation is mainly used for controlling the 3D printer to cool the nozzle, and to return the filament to the nozzle, in this way, the 3D printer can exchange the filament, or turn off.

In an exemplary embodiment, the second condition records a second pressing frequency, step S102 determines that the operation content of the second operation input matches the second condition if the user presses the button with the second pressing frequency (that is, the operation content of the second operation input is pressing the button with the second pressing frequency). The second pressing frequency is different from the aforementioned first pressing frequency (that is, the second condition is different from the first condition).

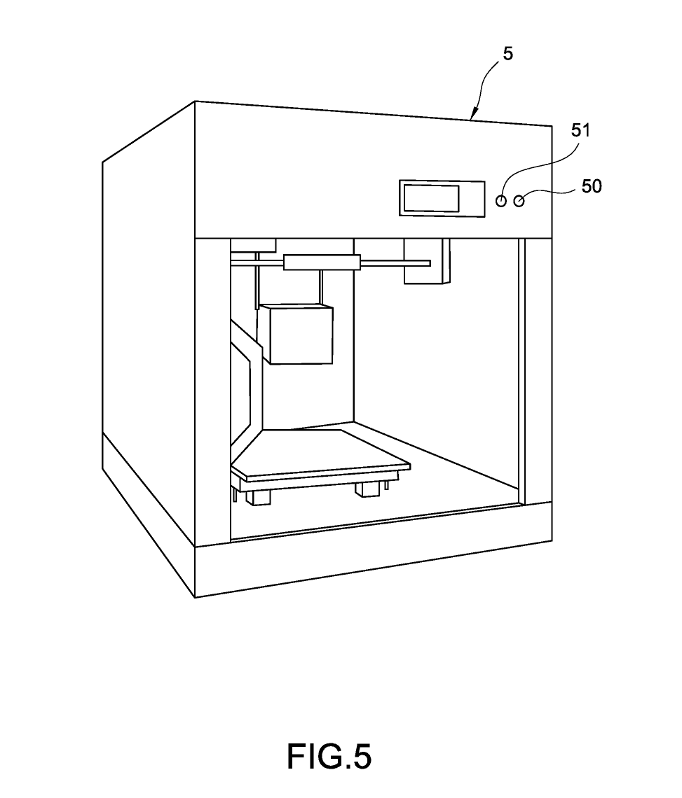

Please refer to FIG. 1 and FIG. 5 together, FIG. 5 shows a diagram of a 3D printer using the method according to a first exemplary embodiment of the present disclosure. The exemplary embodiment in FIG. 5 discloses a 3D printer 5; the 3D printer 5 has a single button 50 and provides user operation through the button 50.

In an exemplary embodiment, the 3D printer 5 has at least a single color LED, in this way, the 3D printer 5 represents different states by different light. As shown in FIG. 5, the 3D printer 5 has a single color LED 51.

For example, in a standby mode, the 3D printer 5 may keep determining if the button 50 is triggered from outside. If the 3D printer 5 is in the standby mode and determines the user keeping pressing the button 50 for a predetermined time period (for example, 3 sec, that is, keeping pressing the button 50 for 3 sec is regarded as the first operation input), the 3D printer 5 may further enter the feeding and returning filament mode from the standby mode.

After the 3D printer 5 enters the feeding and returning filament mode, the 3D printer 5 waits for a specific time period, and determines if the button 50 is triggered by external operation again in the specific time period. If the 3D printer 5 is in the feeding and returning filament mode and determines that the user presses the button 50 once, the 3D printer 5 will regard the operation content of the second operation input as pressing the button 50 once. Then, the 3D printer 5 further compares the operation content with the plurality of pre-stored conditions, if the operation content matches a pre-stored first condition (for example, recording the first pressing frequency to be once), then the 3D printer 5 performs the feeding operation of the feeding and returning filament mode, for adding the filament to the 3D printer 5.

For another example, if the user presses the button 50 twice in the feeding and returning filament mode of the 3D printer 5, then the 3D printer 5 determines pressing the button 50 twice as the operation content of the second operation input. Afterward, the 3D printer 5 further compares the operation content with the plurality of pre-stored conditions. If the operation content matches a pre-stored second condition (for example, recording the second pressing frequency as twice), then the 3D printer 5 performs the returning operation of the feeding and returning filament mode to make the 3D printer 5 return the filament.

Specifically, a power source of the 3D printer 5 of the present disclosure is changed to a pulse constant-current source, and a pulse width is changed through pulse width modulation (PWM), thus a brightness of the single color LED 51 is changed. In this way, the 3D printer 5 may display a current state by the single color LED 51. For example, if the 3D printer 5 is in the standby mode, the single color LED 51 may be controlled to be constant lighting. If the 3D printer 5 performs the feeding operation or the returning operation of the feeding and returning filament mode, the single color LED 51 may be controlled to be breathing light.

In an exemplary embodiment, the 3D printer 5 sets a pulse width of the single color LED 51 to be a maximal value (100%) to make the single color LED 51 be a constant light. In another exemplary embodiment, the 3D printer 5 decreases the pulse width of the single color LED 51 from 100% to 0% of the maximal value, by a fixed rate in a fixed time interval (for example, decreasing 10% each 0.2 sec) repeatedly, then increases the pulse width of the single color LED 51 from 0% to 100% of the maximal value by the same rate and in the same time interval to make the single color LED 51 be a breathing light.

In the present disclosure, a firmware of the 3D printer 5 may be configured to start counting at the moment when a pressing signal of the button 50 changes from low level to high level (that is, when the button 50 is pressed). After an elapsed time of more than 3 sec (that is, the button 50 is pressed for more than 3 sec), the3D printer 5 enters the feeding and returning filament mode. For another example, if the 3D printer 5 is in the feeding and returning filament mode, the 3D printer 5 may be configured to start counting at the condition when a pressing signal of the button 50 changes from low level to high level and immediately changes from high level to low level (that is, the button 50 is quickly pressed once). Moreover, if the pressing signal keeps unchanged for 3 sec (that is, the button 50 is not pressed again for more than 3 sec), the 3D printer 5 starts to perform the feeding operation. Besides, the 3D printer 5 is configured to start counting at the condition when the pressing signal of the button 50 changes from low level to high level, and immediately changes from high level to low level (that is, the button 50 is quickly pressed once), and the pressing signal is changed once again within 3 sec (that is, the button 50 is pressed twice within 3 sec) the 3D printer 5 starts to perform the returning operation.

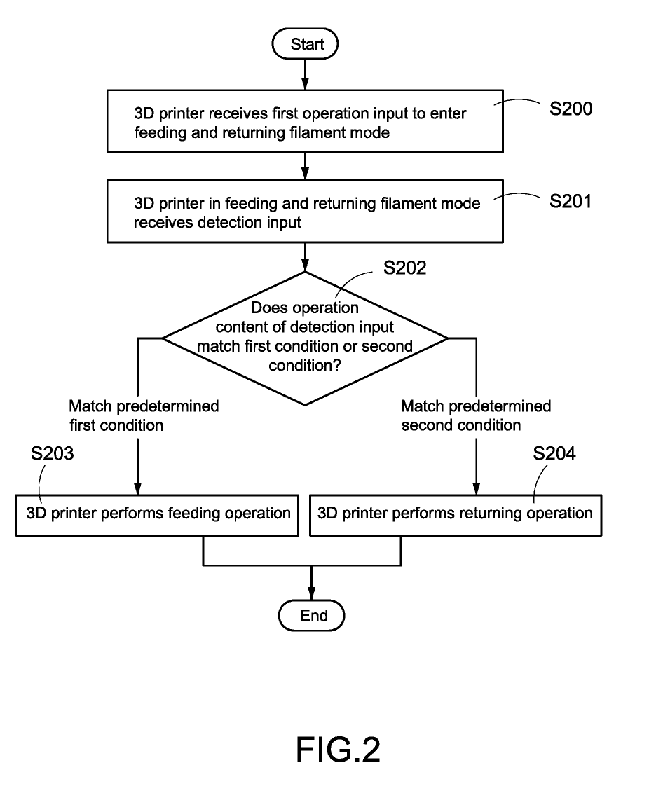

Please refer to FIG. 2, FIG. 2 shows a flowchart of a method of feeding and returning filament according to a second exemplary embodiment of the present disclosure. Specifically, the exemplary embodiment in FIG. 2 differs from the aforementioned first exemplary embodiment in that, an input of the second operation according to the second exemplary embodiment is a detection input, which is different from the button input in the first exemplary embodiment. Specifically, in step S200 of the exemplary embodiment, the 3D printer 5 receives a first operation input to enter the feeding and returning filament mode, in step S201 the 3D printer 5 in the feeding and returning filament mode receives a second operation input. Those steps are same as or similar to steps S100 and S101 of the first exemplary embodiment, detailed description is not repeated here.

Specifically, after the 3D printer 5 receives the first operation input and enters the feeding and returning filament mode, the 3D printer 5 further receives the second operation input (in the exemplary embodiment, the second operation input is the detection input), and enters step S202 to determine a operation content of the detection input. In the exemplary embodiment, the operation content of the detection input at least includes two results, namely, detecting filament and not detecting filament.

In the exemplary embodiment, if the 3D printer 5 enters the feeding and returning filament mode and the filament is not detected within a specific time period, then it is determined that the operation content matches the first condition (that is, the first condition records the result of not detecting filament), and step S203 is performed. In step 203 the 3D printer 5 performs the feeding of the feeding and returning filament mode.

If the 3D printer 5 enters the feeding and returning filament mode and the filament is detected within the specific time period, then it is determined that the operation content matches the second condition (that is, the second condition records the result of detecting filament), and step S204 is performed. In step 204 the 3D printer 5 performs the returning operation of the feeding and returning filament mode.

Please refer to FIG. 2 and FIG. 5 together, for example, if the 3D printer 5 is in the standby mode, user may keep pressing the button 50 for 3 sec (that is, keeping pressing the button for 3 sec is regarded as the first operation input) to make the 3D printer 5 enter the feeding and returning filament mode.

After the 3D printer 5 enters the feeding and returning filament mode, the 3D printer 5 may receive a filament detection result (that is, the detection input) by a detection unit (not shown). If the filament detection result displays that the filament is not detected (that is, it is determined that the operation content of the detection input matches the first condition), then the 3D printer 5 performs the feeding operation of the feeding and returning filament mode to add a filament to the 3D printer 5. Contrarily, if the filament detection result displays that the filament is detected (that is, it is determined that the operation content of the detection input matches the second condition), then the 3D printer 5 performs the returning operation of the feeding and returning filament mode to make the 3D printer 5 returns the filament.

Similarly, in the exemplary embodiment, the 3D printer 5 has a single color LED 51, thus the 3D printer 5 may represent different states by different light status. The light and the button 50 operate the same way as that of the aforementioned exemplary embodiment, detailed description is not repeated here.

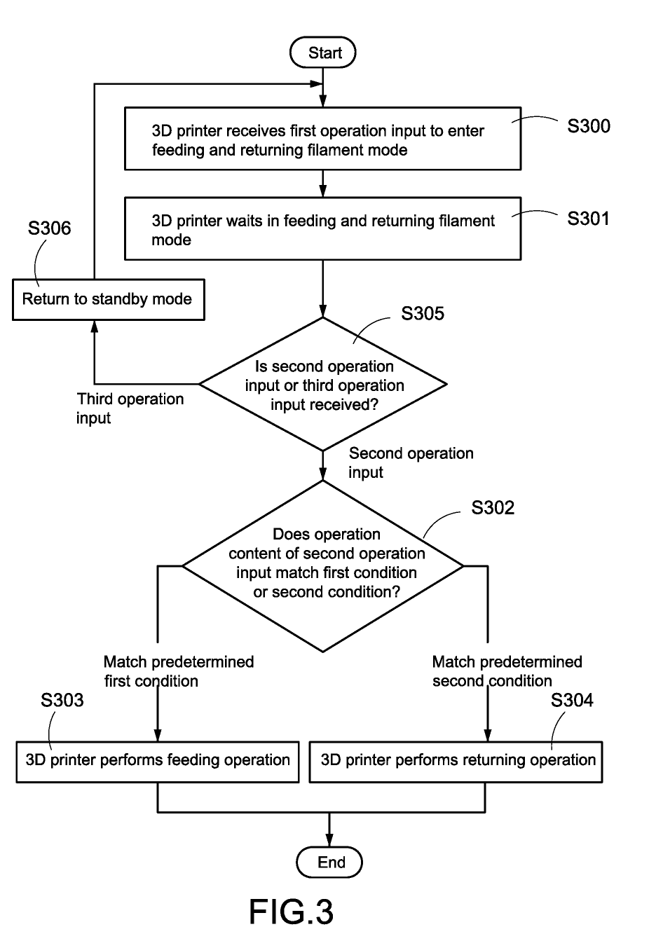

Please refer to FIG. 3, FIG. 3 shows a flowchart of a method of feeding and returning filament according to a third exemplary embodiment of the present disclosure. In step S300 of the exemplary embodiment the 3D printer receives a first operation input to enter the feeding and returning filament mode. In step S301, the 3D printer in the feeding and returning filament mode waits for receiving one of the plurality of operation inputs. In step S302, the 3D printer determines an operation content of the second operation input. Instep S303, the 3D printer performs the feeding operation of the feeding and returning filament mode. In step S304, the 3D printer performs the returning operation of the feeding and returning filament mode. Steps 300-304 are the same as or similar to step S100, step S101, step S102, step S103 and step S104 of the aforementioned first exemplary embodiment respectively, detailed description is not repeated here. The exemplary embodiment and the aforementioned first exemplary embodiment are different in that, the 3D printer according to the exemplary embodiment in the feeding and returning filament mode may receive a plurality of different operation inputs, and further include step S305 and step S306.

Specifically, after the 3D printer receives the first operation input, the 3D printer enters the feeding and returning filament mode and waits. In the exemplary embodiment, in step S305 the 3D printer determines if the second operation input or a third operation input is received within a specific time period, after entering the feeding and returning filament mode. An input content of the third operation input is different from that of the second operation input.

In the exemplary embodiment, after the 3D printer enters the feeding and returning filament mode, it is determined that if the second operation input and the third operation input are received within the specific time period. If the second operation input is received within the specific time period, then the 3D printer further performs step S302 to determine to perform the feeding operation or the returning operation of the feeding and returning filament mode (as shown in the first exemplary embodiment above). Contrarily, if the third operation input is received within the specific time period, then the 3D printer will return to the standby mode (that is, performing step S306), and not perform the feeding operation and the returning operation. Besides, after the 3D printer returns to the standby mode, if the user wants the 3D printer to perform the feeding operation or the returning operation, then the first operation input needs to be performed to the 3D printer again.

In the exemplary embodiment, the operation content of the third operation input may, for example, be keeping pressing (holding down) the button for a predetermined time period (for example, larger than or equal to 3 sec), but not limited.

Please refer to FIG. 3 and FIG. 5 together, for example, if the 3D printer 5 is in the standby mode, the user may keep pressing (hold down) the button 50 for 3 sec (that is, keeping pressing the button for 3 sec is regarded as the first operation input) to make the 3D printer 5 enter the feeding and returning filament mode.

After the 3D printer 5 enters the feeding and returning filament mode, if the user does not perform button input (that is, the 3D printer 5 does not receive the second operation input and the third operation input) in a specific time period (for example, two minutes), or the user keeps pressing the button 50 for 3 sec (the third operation input mentioned above), then the 3D printer 5 returns to the standby mode.

Contrarily, if the user quickly presses (clicks) the button 50 once (that is, the operation content of the second operation input is quickly pressing the button 50 once) within the specific time period, the 3D printer 5 determines that the second operation input is received, and the operation content of the second operation input matches first condition, thus the feeding operation of the feeding and returning filament mode is performed to add a filament to the 3D printer 5.

Moreover, if the user quickly presses (clicks) the button 50 twice within the specific time period (that is, the operation content of the second operation input 50 is quickly pressing the button twice), the 3D printer 5 determines that the second operation input is received, and the operation content of the second operation input matches second condition, thus the returning operation of the feeding and returning filament mode is performed to make the 3D printer 5 return the filament.

In the exemplary embodiment, the operation content of the third operation input is different with the operation content of the second operation input, in this way, the 3D printer 5 may determine (according to the operation content of the second operation input, and the operation content of the third operation input) that user makes the 3D printer 5 return to the standby mode, perform the feeding operation, or perform the returning operation.

Similarly, in this way, the 3D printer 5 represents different states by different light in the exemplary embodiment, the 3D printer 5 has a single color LED 51. The light and the button 50 operate the same as the aforementioned exemplary embodiment, detailed description is not repeated here.

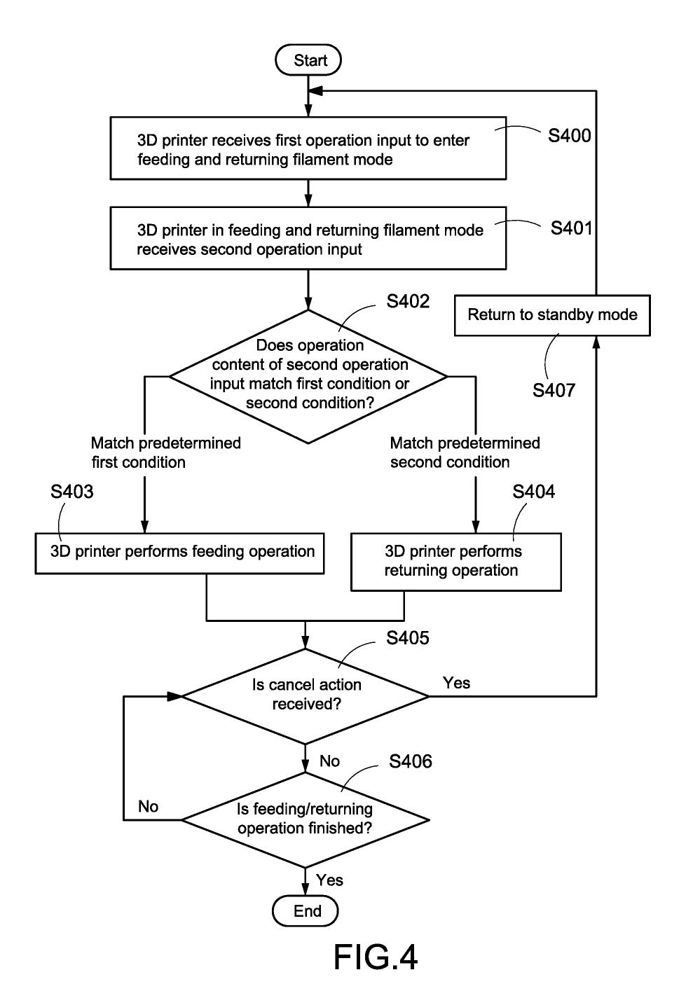

Please refer to FIG. 4, FIG. 4 shows a flowchart of a method of feeding and returning filament according to a fourth exemplary embodiment of the present disclosure. Specifically, in step S400 of the exemplary embodiment, the 3D printer receives a first operation input to enter the feeding and returning filament mode. In step S401 the 3D printer in the feeding and returning filament mode receives a second operation input. In step S402 the 3D printer determines an operation content of the second operation input. In step S403 the 3D printer performs the feeding operation of the feeding and returning filament mode. In step S404 the 3D printer performs the returning operation of the feeding and returning filament mode. Steps 400-404 are the same as or similar to step S100, step S101, step S102, step S103 and step S104 of the first exemplary embodiment mentioned above respectively, detailed description is not repeated here. The exemplary embodiment and the aforementioned first exemplary embodiment are different in that, compared to the aforementioned first exemplary embodiment, the exemplary embodiment further includes step S405, step S406 and step S407.

Specifically, step S405 determines if a cancel action is received after the 3D printer starts to perform the feeding operation or the returning operation. If yes, then step S407 is performed, that is, controlling the 3D printer to return to the standby mode. If the 3D printer determines that cancel action is not received in step S405, then step S406 is performed to further determine if the feeding operation or the returning operation is finished. Besides, the 3D printer keeps performing step S405 before the feeding operation or the returning operation is finished to keep determining if the cancel action is received. Besides, the 3D printer ends flowchart after the feeding operation or the returning operation.

In an exemplary embodiment, the cancel action may be a button action, for example, the user keeps pressing the button for a period of time (for example, 3 sec) to force the 3D printer to interrupt the feeding operation or the returning operation, and to return to the standby mode.

Please refer to FIG. 4 and FIG. 5 together, for example, if the 3D printer 5 is in the standby mode, the user may keep pressing the button 50 for 3 sec (that is, keeping pressing the button 50 for 3 sec is regarded as the first operation input) to make the 3D printer 5 enter the feeding and returning filament mode.

In the feeding and returning filament mode of the 3D printer 5, the user may press the button 50 once (that is, the operation content of the second operation input is pressing the button 50 once) or twice (that is, the operation content of the second operation input is pressing the button 50 twice) to make the 3D printer 5 perform the feeding operation or the returning operation of the feeding and returning filament mode.

In the exemplary embodiment, if the user keeps pressing (holds down) the button 50 for 3 sec (that is, the operation content of the cancel action is keeping pressing the button 50 for 3 sec) before the feeding operation or the returning operation is finished, then the 3D printer 5 will directly interrupt the feeding operation or the returning operation, and return to the standby mode (that is, performing step S407, and returning to step S400). In the exemplary embodiment, the user may force the 3D printer to interrupt performing the feeding operation or the returning operation by the cancel action, if the 3D printer 5 malfunctions while performing the feeding operation or the returning operation to remove the malfunction.

Similarly, in the exemplary embodiment, the 3D printer 5 has a single color LED 51, thus the 3D printer 5 may represents different states by different lights. The light and the button operate the same as that of the aforementioned exemplary embodiment, detailed description is not repeated here.

The method of feeding and returning filament provided by the present disclosure can enhance convenience of operation with limited buttons of the 3D printer.

Thus, particular exemplary embodiments have been described. Other exemplary embodiments are within the scope of the following claims. For example, the actions recited in the claims may be performed in a different order and still achieve desirable results.

What is claimed is:

1. A method of feeding and returning filament for 3D printer used for a 3D printer having a button, and the method comprising:
receiving a first operation input to the 3D printer through the button;
controlling the 3D printer to enter a feeding and returning filament mode after receiving the first operation input, and to receive a second operation input in the feeding and returning filament mode;
determining an operation content of the second operation input while receiving the second operation input;
performing a feeding operation in the feeding and returning filament mode while the operation content matching a first condition, wherein the feeding operation is used for adding a filament to the 3D printer; and
performing a returning operation in the feeding and returning filament mode while the operation content matching a second condition, wherein the returning operation is used for making the 3D printer return the filament.

2. The method of claim 1, wherein the method further comprises a step f: after step b, controlling the 3D printer to enter a standby mode if the second operation input being not received within a specific time period.

3. The method of claim 1, wherein the method further comprises a step g: controlling the 3D printer to enter a standby mode, if a third operation input being received in the feeding and returning filament mode, wherein the third operation input is different from the second operation input.

4. The method of claim 3, wherein the third operation input is keeping pressing the button and for a predetermined time period.

5. The method of claim 4, wherein the predetermined time period is larger than or equal to 3 sec.

6. The method of claim 1, wherein the method further comprises a step h: controlling the 3D printer to enter a standby mode after the feeding operation or the returning operation being finished.

7. The method of claim 1, wherein the first operation input is keeping pressing the button for a predetermined time period.

8. The method of claim 7, wherein the predetermined time period is larger than or equal to 3 sec.

9. The method of claim 1, wherein the first operation input is a specific number of pressing on the button within a short pressing time.

10. The method of claim 1, wherein the second operation input is a button input, step d determines the operation content matching the first condition when the button input is pressing the button with a first pressing frequency; step e determines the operation content matching the second condition when the button input is pressing the button with a second pressing frequency, wherein the first pressing frequency is different from the second pressing frequency.

11. The method of claim 1, wherein the second operation input is a detection input, step c is determining the operation content matching the first condition, if the detection input is no filament detected in a specific time period; step e is determining the operation content matching the second condition, if the detection input is the filament detected in the specific time period.

12. The method of claim 1, wherein in step a, the 3D printer receives the first operation input in a standby mode.

13. The method of claim 1, wherein the 3D printer has at least a single color LED, the 3D printer sets a pulse width of the single color LED to be a maximal value in a standby mode to make the single color LED be a constant light; wherein the 3D printer decreases the pulse width of the single color LED from 100% to 0% of the maximal value in the feeding operation or the returning operation by a fixed rate in a fixed time interval, then increases the pulse width of the single color LED from 0% to 100% of the maximal value by the same fixed rate in the fixed time interval to make the single color LED be a breathing light.
